(19) United States
(12) Patent Application Publication
(10) Pub. No.: US 2013/0097081 A1
(43) Pub. Date: Apr. 18, 2013

(54) ELECTRONIC PAYMENT PROCESSING

(71) Applicant: Boost Payment Solutions, LLC, New York, NY (US)

(72) Inventors: Dean Michael Leavitt, Scarsdale, NY (US); James Edward Lister, New York, NY (US)

(73) Assignee: Boost Payment Solutions, LLC, New York, NY (US)

(21) Appl. No.: 13/649,935

(22) Filed: Oct. 11, 2012

Related U.S. Application Data
(60) Provisional application No. 61/546,412, filed on Oct. 12, 2011.

(51) Int. Cl. G06Q 20/22; G06Q 20/40

(52) U.S. Cl. 705/44; 705/39

(57) ABSTRACT

A payment message is received from a buyer relating to a transaction with a merchant. The payment message is parsed to obtain merchant identifying information, and further parsed to obtain at least some payment information for the transaction. The payment information is submitted to a third party settlement processor on behalf of the merchant. The results of the transaction are reported to at least one of the merchant and the buyer.

### RELATED APPLICATION

This application claims priority to U.S. Provisional Application No. 61/546,412, filed Oct. 12, 2011, entitled “VIRTUAL CARD ACCEPTANCE,” the contents of which are hereby incorporated by reference in their entirety.

### BACKGROUND INFORMATION

Electronic systems for handling various payments between government, corporate, or institutional (i.e., non-consumer) customers (also referred to herein as “buyers”), and their suppliers, vendors and other payees (all of whom may sometimes be referred to as “merchants”), face challenges. For example, mechanisms are lacking for processing payments made via non-physical payment cards, i.e., payment card accounts lacking an actual physical plastic card. Non-physical payment cards may include a so-called “ghost card” as well as one-time use cards, often referred to as a “virtual card.”

One present system requires a customer cardholder wishing to make a payment to its supplier or vendor (to the extent there is any difference between them, merchants, suppliers and vendors alike are referred to herein as suppliers) to notify its issuing bank of its desire to do so. Notice may be then be provided to the supplier, which must then enter card data, an amount of the payment, date of payment, invoice number(s), etc., to which the payment applies, and other payment-related data that may be required, into a point of sale terminal, processing software, or other card acceptance system that has been provided to the supplier by its merchant bank in order to submit card transactions for processing and ultimate funding. For a ghost card or a one-time use card, an e-mail notification may be sent to the supplier identifying invoices to be paid, the amount of each, and the overall payment amount to be applied to the card.

Further, present card payment mechanisms are fraught with security risks. For example, buyers are often exposed to fraud by merchants who, under present mechanisms, receive access to the buyer's cards data (account number, expiration date, etc.). Moreover, such security risks have engendered many and complex laws, rules, and regulations governing the security and compliance obligations to which card issuers and merchants must adhere. These laws, rules, and regulations cause transactions to be unduly difficult and expensive. In addition, the foregoing issues have slowed acceptance of use of payment cards for commercial transactions.

Thus, current processes are time-consuming, cumbersome, risky, and fraught with potential errors. Furthermore, in the likely event that the supplier participates in multiple virtual card and ghost card programs from multiple customers, the burden is amplified and further complicated by the fact that various virtual card programs have their own set of operational idiosyncrasies and logon credentials that must be managed by the supplier, and moreover ghost cards generally require the supplier to securely house the card information yet be able to quickly retrieve it to complete the payment instructions.

### BRIEF DESCRIPTION OF THE DRAWINGS

FIG. 1 is a block diagram of a system for processing payment card transactions.

FIG. 2 provides an exemplary illustration of a merchant profile table.

FIG. 3 provides an exemplary illustration of a transaction reference table.

FIG. 4 illustrates an example of payment data in the form of an email where the mode of payment is via a ghost card.

FIG. 5 illustrates an example of payment data in the form of an email where the mode of payment is via a virtual card.

FIG. 6 illustrates an example of confirmation data in the form of an email to a supplier.

FIG. 7 illustrates an exemplary process for processing a payment on behalf of the supplier.

### DETAILED DESCRIPTION OF PREFERRED EMBODIMENTS

### Introduction

Disclosed herein are certain systems, apparatuses, and methods, including such as may be embodied as instructions stored on a computer-readable medium and executable by a processor. For example, mechanisms may be used to receive transaction-related data sent by a payment card issuer (“issuer”), or a third party serving as issuer's and/or payer's proxy, to a supplier via secure file transfer, secure e-mail, or secure facsimile. Alternatively or additionally, mechanisms may be used to retrieve transaction-related data from one or more issuer web portals and/or via an internet protocol IP connection or the like with such issuers on behalf of one or more suppliers. Then, usernames, passwords and other security features embedded in such messages may be extracted, whereupon a logon to an issuer's virtual card website/portal may be performed. Secure card data intended for the supplier and related to the payment transaction may then be accessed. The issuer or buyer may opt to provide payment instructions via a direct secure connection to expedite the delivery of payment transaction process.

Once transaction data is accessed, card data may be associated with the supplier's unique merchant ID (“MID”) and invoice information to which the payment applies. After the card data, MID and invoice information are associated, or matched, payment may be processed on behalf of the supplier that has provided authorization to facilitate its transactions, thereby eliminating the need for the supplier to access payment transaction data and process the transaction at the direction of its customer itself.

Upon the authorization and settlement (or declination) of a transaction, a supplier may be notified via one or more mechanisms, including e-mail, facsimile, or an IP connection, that the transaction has been completed and that the funds will be deposited into the supplier's designated depository account. The original buyer notice for a call to action by the supplier is converted to a notification that the action has been successfully completed. If declined, a reason code and descriptor may be provided to the issuer or customer/buyer so that the supplier will not have to deal with buyer-issuer directed payment declines.

To facilitate the foregoing mechanisms, a supplier generally will provide necessary permissions and proxies giving authorization to receive card data and process such transactions on the supplier's behalf and will generally provide instructions (e.g., via a specially assigned email address) to the ghost/virtual card issuing bank to redirect (or send a copy of) all ghost/virtual card-related messages scheduled to be delivered to the supplier via a specified mechanism such as the specially assigned e-mail address. Certain issuers may have the capability to transmit such messages directly via a secure IP connection in lieu of an e-mail/facsimile.

Credits are generally not allowed with virtual cards (e.g., because they are single-use), but a credit refund can be issued on a ghost card. In this case, an issuer's communication, e.g., e-mail, may be re-directed to the supplier. The supplier may then be required to provide a confirmation to process the refund before the transaction is securely processed on the supplier's behalf.

In general, card data is not exposed to the supplier (i.e., the merchant) at any time, as Payment Card Industry Data Security Standard (PCI DSS) compliance is maintained. Thus, the presently disclosed mechanisms advantageously create a secure environment in which the risk of merchant fraud is greatly reduced. Further, because the merchant never accesses card data, the merchant is advantageously relieved of obligations to adhere to various security requirements, such as PCI requirements.

In short, the present disclosure includes mechanisms by which a buyer-initiated one time use or ghost transaction may be processed on behalf of a merchant. That is, a transaction may be proxied, or emulated, on behalf of a supplier in a manner that yields the same result for a supplier as a transaction in which the buyer initiates a transaction directly to the merchant (i.e., supplier), but with significant efficiencies for the supplier and greatly reduced risk for all parties (e.g., the card issuer, the buyer, and the supplier).

### System Overview

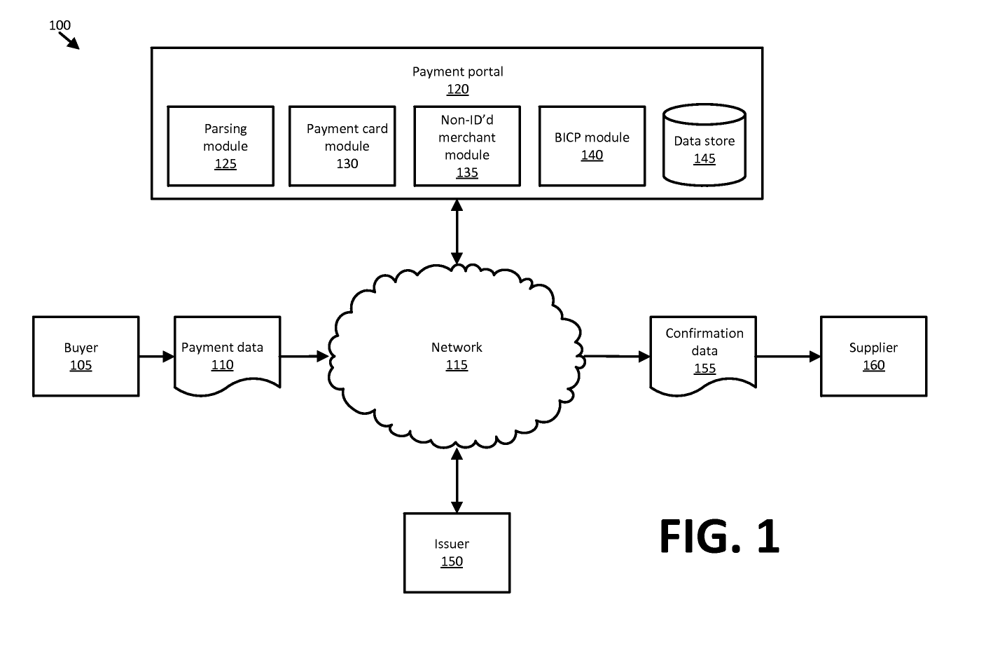

FIG. 1 is a block diagram of a system 100 for processing payment card transactions. A buyer 105 transmits sends a payment message that includes payment data 110, e.g., via a network 115, to a payment portal 120. Various modules such as a parser module 125, a card payment module 130, a non-identified merchant module 135, a buyer initiated card payment (BICP) module 140, etc., may be included in the portal 120, which may also include a data store 145. The different modules 125, 130, 135, 140 may process different kinds of data and/or transactions. The payment data 110 may have been formatted for transmission to an issuer 150 but instead may be intercepted by the portal 120 which processes the data 110 in one or more of the modules 125, 130, 135, 140, and communicates with the issuer 150, whereupon the portal 120 may send confirmation data 155 to a supplier 160.

The buyer 105 is generally a purchaser of goods and/or services from the supplier 160. The buyer 105 generally includes one or more computing devices having computer-executable instructions for formatting and sending payment data 110 as well as for performing other operations disclosed herein.

The buyer 105 provides the payment data 110 in an electronic format, generally as a message that may be referred to as a “payment message,” such as in an email, on a webpage, in extensible markup language (XML), or according to some other electronic format. The payment data 110 includes information relating to the buyer 105, and generally further identifies one or more suppliers 155 and one or more payments to be made to the one or more suppliers 155. For example, payment data 110 may include an identifier indicating a buyer 105, card information, information relating to one or more invoices, such as invoice amount(s), identifying numbers, an indicator concerning whether a card is a debit card or credit card, etc.

The network 115 is generally a packet network, e.g., operating according to transfer control protocol/Internet protocol (TCP/IP). Although one network 115 is shown, the network 115 may include one or more networks and may include various elements such as switches, routers, convention computer servers, virtual computer servers, etc., the one or more networks being a network such as the Internet, a wide area network, a local area network, a cellular network, a wireless network, etc.

Portal 120 generally includes one or more computer servers, i.e., devices with one or more processors and one or more memories, that host one or more of the modules 130, 135, 140. References herein to the portal 120 collectively encompass such one or more computer servers. The portal 120 selectively communicates, e.g., via the network 115, with one or more computer servers included in one or more buyers 105, one or more issuers 150, and/or one or more suppliers 160. In addition to the modules 130, 135, 140, the portal 120 may include other modules or sets of computer-executable instructions for performing operations as disclosed herein. For example, the portal 120 generally includes instructions for receiving payment data 110, sending confirmation data 155, and otherwise communicating with other elements in the system 100, managing communications between modules included within the portal 120, etc.

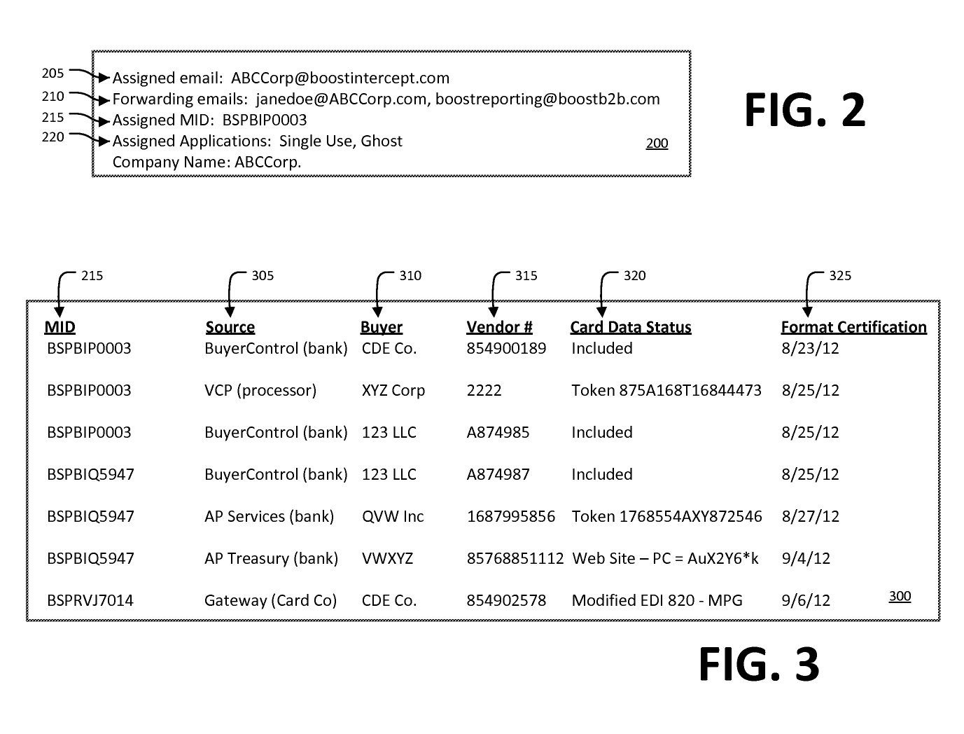

The portal 120 generally also includes the data store 145, which may itself be a separate storage device and/or a database such as a relational database. In general, the data store 145 may be included in or communicatively coupled to a server included in the portal 120. In any event, the portal 120 data store 145 generally includes information for processing payment transactions on behalf of one or more merchants. As used herein, “merchant” refers to any party that is the recipient or intended recipient of a payment. Thus, information included in the data store 145 may include a merchant identifier, also referred to as a merchant ID, that uniquely or substantially uniquely identifies a supplier 160, one or more email addresses via which payment data 110 may be sent to the portal 120 on behalf of a particular supplier 160 by one or more buyers 105, information concerning how a payment is to be processed and/or payment card information (e.g., an account number, expiration date, a security code, etc.), as well as other information associated with a merchant, such as a company name, address, contact information, etc. Further details concerning exemplary information included in the data store 145 are provided below, including with respect to FIGS. 2 and 3.

The parsing module 125 parses payment data 110 to identify various information. For example, the parsing module 125 generally obtains information identifying a supplier 155 on whose behalf a payment is to be processed. For example, if payment data 110 is included in an email, the parsing module 125 may identify the destination address of the email, which then may be associated with a particular supplier 160 as described further below. That is, the portal 120 may receive email messages from a variety of sources including a variety of destination addresses. As described further below, by matching both a merchant ID and a destination email address and/or other information included in payment data 110, the parsing module 125 may identify specific steps for processing a payment transaction identified in the payment data 110. For example, a unique or substantially unique email address assigned to a supplier 160 may identify a merchant ID associated with the supplier 160, which in turn provides a mechanism for looking up instructions and/or requirements specific to a supplier 160 and/or a buyer 105 in the in the data store 145.)

Information obtained by the parsing module 125 is used to determine what additional module or modules the portal 120 may use for processing a payment transaction indicated by the parsed payment data 110. For example, the card payment module 130 includes instructions for processing payment data 110 that can be matched to a merchant identifier stored in the data store 145. The non-identified merchant module 135 includes instructions for processing payment data 110 that cannot be matched to a merchant identifier stored in the data store 145, e.g., that is sent to an email address not associated with any merchant identifier in the data store 145. Further, BICP module 140 may be invoked when the parsing module 125 determines that payment data 110 is intended to initiate a buyer initiated card payment transaction, e.g., through a BICP specific payment gateway. Operations of the modules 130, 135, 140 are described further below.

### Exemplary Data Elements

FIG. 2 provides an exemplary illustration of a merchant profile table 200 that may be included in the data store 145.

An assigned email field 205 stores an email address assigned to a merchant, i.e., supplier 160, associated with a record in the table 200. This email address may be used by the buyer 105, or often by a proxy for the buyer 105, as discussed below, to send payment data 110 to the portal 120. The portal 120 may then match an email address in payment data 110 to an email address stored in assigned email field 205 to identify a supplier 160 on whose behalf a payment transaction is to be processed.

A forwarding emails field 210 stores one or more email or other messaging addresses to which payment data 110 is to be forwarded. For example, the portal 120 may include instructions to forward payment data 110 to the addresses specified in the forwarding emails field 210. Alternatively or additionally, the portal 120 may include instructions to send other information, e.g., confirmation data 155, to addresses specified in the forwarding emails field 210.

An assigned merchant ID (MID) field 215 stores a unique or substantially unique identifier for the supplier 160.

An assigned applications field 220 lists one or more payment applications available to the supplier 160 associated with the given record in the table 200. Possible payment applications include private label applications, electronic funds transfer, line of credit, credit card, etc. For example, “Single Use” specifies that an application processing a payment utilizing a virtual, or single use, card may be used for transactions involving the supplier 160 and/or buyer 105. “Ghost” specifies that an application processing a payment utilizing a ghost card may be used for transactions involving the supplier 160 and/or buyer 105. Further, “Gateway,” not shown in FIG. 2, may be used to specify that a payment gateway, e.g., the MasterCard Payment Gateway, may be used. Also not shown in FIG. 2, a “VAR” may be used to specify that payment data 110 may be sent to a value added reseller or partner of the portal 120 for processing.

A company name field 225 provides a name of the supplier 160. This name may be used in emails, reports, or the like.

FIG. 3 provides an exemplary illustration of a transaction reference table 300 that may be included in the data store 145. Records in the transaction reference table 300 include an MID 215, described above with respect to FIG. 2.

Further, the table 300 includes a source field 305. The source field 305 includes a source of payment data 110. As mentioned above, payment data 110 may be provided by a buyer 105, but often is provided only indirectly by the buyer 105, i.e., is provided by a payment processing entity, e.g., an application provider, on behalf of the buyer 105. Thus, the source field 305 identifies this entity, whether it be the buyer 105 itself or some other entity.

A buyer field 310 identifies the buyer 105. As just mentioned, in some cases, the data in the source field 305 may match the data in the buyer field 310.

A vendor number field 305 stores a vendor number used by the buyer 105 indicated in the buyer field 310. The vendor number is generally a unique or substantially unique supplier 160 identifier assigned by the buyer 105 to the supplier 160 within its accounts payable system. Further, a buyer 105 may associate one or more vendor numbers with a supplier 160. For example, if the buyer 105 uses different vendor numbers to manage different business segments within the buyer 105 organization, for different reporting needs or for different modes of payment with respect to one supplier 160, e.g., some invoices are paid with a ghost card and some invoices are paid with a virtual card, then the buyer 105 may have a first vendor number for the supplier 160 indicating that the mode of payment is with a ghost card, and a second vendor number for the same supplier 160 indicating a virtual card mode of payment.

A card data status field 320 includes information for obtaining payment card information. For example, “Included” in the field 320 means that card data, such as a card account number, expiration date, etc., is to have been included in the payment data 110. For example, payment data 110 may be an encrypted email, and the parsing module 125 may include instructions to parse card data from the encrypted email.

An indication of a “Token” in the field 320, generally followed by a token identifier, is generally found where payment data 110 is to be used to process a payment using a ghost card. A token is a unique or substantially unique identifier for ghost card information, e.g., the card account number, expiration date, etc., and may be used to secure the ghost card information. The ghost card information, including a card number and other information necessary to place a charge on the ghost card, may be placed in a data store maintained by a third party processor sometimes referred to as a value-added reseller (VAR) (not shown in FIG. 1). The token, used in lieu of the actual ghost card number, may be used to obtain authorization from a card issuer 150 to charge the ghost card.

An indication of “website” in the field 320, generally followed by an identifier for a website, uniform resource locator (URL), etc. may indicate that payment card information is to be obtained from a third party or buyer 105 website, or some other remote mechanism, such as obtaining payment card information by a secure or unsecure messaging protocol, secure file transfer protocol (SFTP or FTPS), etc., as may likewise be indicated.

Further, e.g., in cases where an application assigned to the supplier 160 includes a gateway, the field 320 may indicate a format for a file to be transferred to the gateway. For example, “Modified EDI 820” is a format for transferring payment data 110 to the MasterCard Payment Gateway.

A format certification field 325 indicates a date on which a format notice for payment data 110 and/or confirmation data 155 has been certified, the process being a test that an instruction, email or file, etc., has been received an parsed and that payment instructions were correctly being interpreted by the portal 120, and processed on to the appropriate third party processing application.

The tables 200 and 300 may be used together to process a payment transaction for a supplier 160. For example, the portal 120 may receive payment data 110 from a buyer 105 (or from a proxy for the buyer 105), whereupon the parsing module 125 or some other module in the portal 120 may identify the destination email address that can be matched to an email address in the assigned email field 205 in the merchant profile table 200. Accordingly, the portal 120 can determine the MID stored in the MID field 215 associated with the received email address. The portal 120 may further identify a vendor number in the payment data 110. The portal 120 may then query the transaction reference table 300 using the destination email address and the vendor number in the payment data 110 along with the MID retrieved from the merchant profile table 200 to locate an appropriate record in the table 300 for processing the payment or payments requested in the payment data 110. More specifically, the portal 120 may use contents of the card data status field 320 to obtain, in the cases of virtual card or ghost card transactions, payment card information or information on obtaining such information via a website, message, or the like, or, in the case of a transaction to be processed by a card provider gateway, information about a format of payment data 110 to be sent to the card provider gateway.

### Payment Data Examples

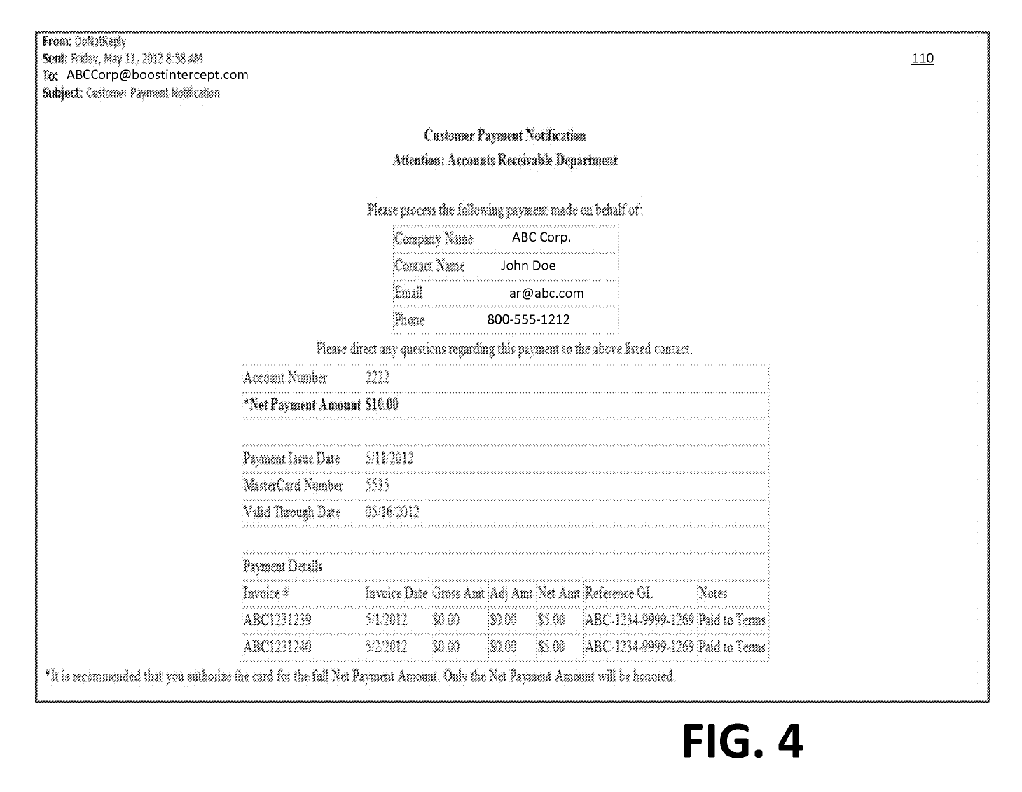

FIG. 4 illustrates an example of payment data 110 in the form of an email where the mode of payment is via a ghost card. The email includes a destination address “ABCCorp@boostintercept.com” that may be recognized by the parser module 125 and matched to an address stored in assigned email field 205. Further, an “Account Number” may be matched to data in a vendor number field 315. Accordingly, the payment data 110 may be used as described above to find a token that in turn may be used to access the ghost payment card information in a card data status field 320; note that the “MasterCard number” provided in the example of FIG. 4 is truncated. Ghost card numbers are generally not provided to buyers 105 in an e-mail notification or the like, but instead are provided once, and upon loading onto a third party processer secure card system tokenized and as such are stored in the table 300 may be passed to a card processor to obtain payment card approval.

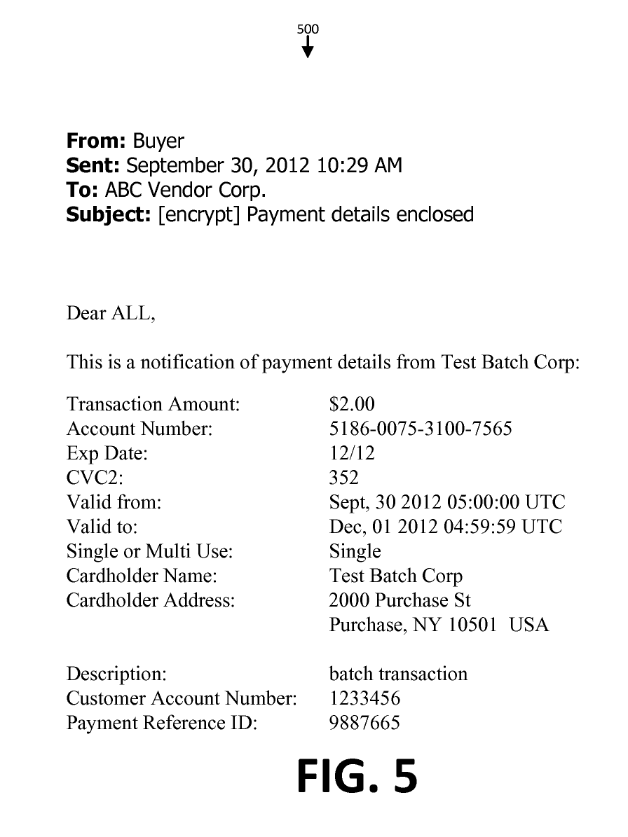

FIG. 5 illustrates an example of payment data 110 in the form of a secure email 500 where the mode of payment is via a virtual single use cards. This email is similar to the email shown in FIG. 4; however, a full, rather than a truncated, card number is provided. Further, the “Customer Account Number” may be matched to data in a vendor number field 315.

### Process Flow

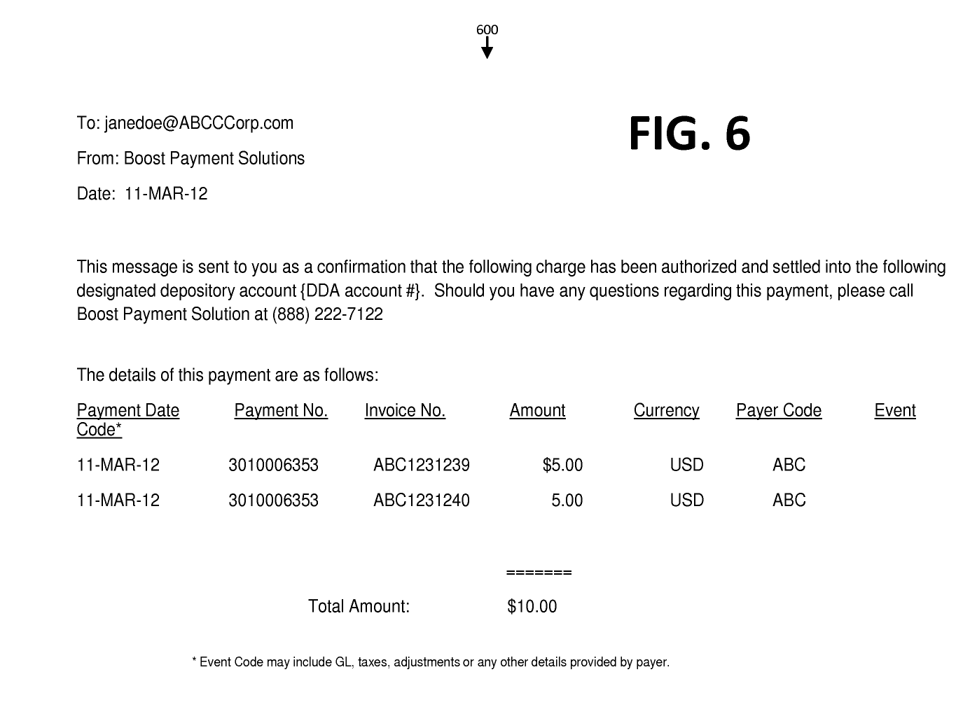

FIG. 6 illustrates an example of confirmation data 155 in the form of an email 600 notifying the supplier 160 identified in the forwarding e-mails field 210 of FIG. 2 which indicate that the payment instruction from the buyer 105 has been successfully authorized, will be settled and funding released into the banking network on or about the next available banking day. If the payment fails to be authorized, the transaction and detail concerning the decline will be routed to a customer service contact to reconcile through a help desk or the like, or to inform the buyer 105 or issuer 150 of the reason for the decline.

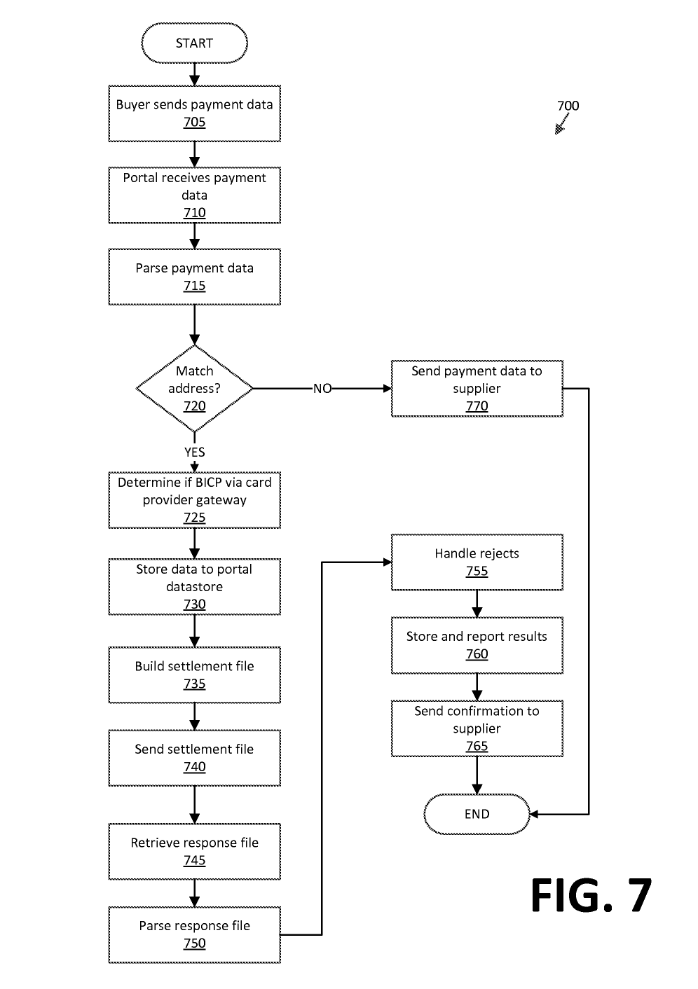

FIG. 7 illustrates an exemplary process 700 for processing a payment on behalf of the supplier 160. The process 700 begins in a step 705, in which a buyer 105 (or an entity acting in behalf of the buyer 105) sends payment data 110, e.g., via the network 115 using e-mail or some other mechanism such as described above, to the payment portal 120.

Next, in a step 710, the portal 120 receives the payment data sent in step 705.

Next, in a step 715, parser 125 parses the payment data 110 received in step 710. The parser 125 may identify a destination email address or other address or identifying information in the data 110 for use in matching data in a merchant ID field 215 in a merchant profile table 200, as described above. Further, the parser 125 may identify other data such as described above, e.g., a vendor number, a card number, payments for one or more invoices, etc. Moreover, in some cases, payment data 110 may be an electronic file or the like that includes payment data 110 relating to multiple transactions possibly with multiple merchants. In that case, a merchant identifier, i.e., an address, name, or some other indicia identifying the merchant, may be included in the payment data 110.

Next, in a step 720, the parser 125 or some other module or instructions included in the portal 120 determines whether a destination address or other identifying indicia parsed from the payment data 110 match data in an assigned email field 205. If a merchant ID or the like is found for the payment data 110, then step 725 is executed next. Otherwise, step 770 is executed next.

Step 725 includes determining whether the portal 120 is to process a payment transaction identified in the payment data 110, or whether the one or more payment transactions identified in the payment data 110 are to be sent to the card provider payment gateway, e.g., the MasterCard Payment Gateway. For example, payment data 110 will generally include an indicator that a transaction is a buyer initiated card payment (BICP), or such determination may be made where payment data 110 lacks a card number or other payment card information, in which case BICP module 140 may execute remaining steps of process 700.

In step 730, information parsed from payment data 110 and/or identified from tables 200 and 300 using information parsed from payment data 110 is stored in the data store 145. For example, in association with a merchant ID, a transaction amount, a date, an invoice number, a payment method, and other information could be stored. This information may then be used to build a settlement file.

Next, in a step 735, the portal 120, e.g., the module 130, builds a settlement file including records representing the payment or payments authorized in the payment data 110. The settlement file usually follows an established flat file format, e.g., a comma separated value (CSV) format as directed by a VAR, such as the Electronic Data Interchange (EDI) modified 820 format used by a payment gateway.

Next, in a step 740, the module 130 sends the settlement file, e.g., via FTP, to an authorization and settlement module that is generally provided by or certified with a third party processor such as First Data Corp. or the like. In any event, the authorization and settlement module requests authorization from the appropriate issuer 150 for the requested payment or payments, and provides confirmation in response to the request for authorization. Occasionally, the authorization and settlement module returns a declination of a payment request.

In the event a file is generated to a card provider for buyer 105 initiated payment processing, only an electronic confirmation of receipt of file is received (see step 760) and no other action or steps need be taken as the gateways perform the confirmation of notification upon successfully processing the transaction.

Next, in a step 745, receives the response from the authorization and settlement module of approval or decline of the payment request.

Next, in a step 750, the module 130 parses the response received in step 740.

Next, in a step 755, in the event any payment request was declined or there was some error in processing the transaction, the module 130 sends a communication, e.g., an email to the relevant help desk or customer service, to contact the buyer 105 and/or issuer 150 that provided the payment data 110.

Next, in a step 760, results received from the authorization and settlement module are stored in data store 145.

Next, in a step 765, confirmation data 155 is sent to the supplier 160, e.g., in the form of an email as seen in FIG. 6.

Following step 765, the process 700 ends.

In step 770, which may follow step 720 as described above, the portal 120 forwards payment data 110 to the supplier 160, e.g., according to instructions in non-identified merchant module 140. Step 770 is generally performed in the case in which payment data 100 includes transactions from a buyer 105 relating to multiple suppliers 160, where some of the suppliers 160 participate in the portal 120, i.e., are listed in data store 145, e.g., in the table 200, and others of the suppliers 160 in the payment data are not found in the data store 145. In this case, payment data 100 generally includes an e-mail address or other contact information for suppliers 160 not included in the data store 145.

Following step 770, the process 700 ends.

### CONCLUSION

Computing devices such as servers included in the portal 120, etc., may employ any of a number of computer operating systems, including, but by no means limited to, versions and/or varieties of the Microsoft Windows® operating system, the iOS by Apple Computer, Inc., Android by Google, Inc., the Unix operating system (e.g., the Solaris® operating system distributed by Sun Microsystems of Menlo Park, Calif.), the AIX UNIX operating system distributed by International Business Machines (IBM) of Armonk, N.Y., and the Linux operating system. Computing devices in general may include any one of a number of computing devices, including, without limitation, a computer workstation, a desktop, notebook, laptop, or handheld computer, or some other computing device.

Computing devices such as those discussed herein generally each include instructions executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, html, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in a computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases or data stores described herein, e.g., data store 145, etc., may include various kinds of mechanisms for storing, accessing, and retrieving various kinds of data, including a hierarchical database, a set of files in a file system, an application database in a proprietary format, a relational database management system (RDBMS), a non-relational database management system , etc. Each such database or data store is generally included within a computing device employing a computer operating system such as one of those mentioned above, and may be accessed via a network in any one or more of a variety of manners. A file system may be accessible from a computer operating system, and may include files stored in various formats. An RDBMS generally employs Structured Query Language (SQL) in addition to a language for creating, storing, editing, and executing stored procedures, such as the PL/SQL language mentioned above. Data store 145 may be any of a variety of known RDBMS packages, including IBMS DB2, or the RDBMS provided by Oracle Corporation of Redwood Shores, Calif. Non-relational database management systems may be any of a variety of known packages, including NoSQL, MongoDB, etc.

With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A method, comprising:
receiving a payment message from a buyer relating to a transaction with a merchant;
parsing, in a computing device the payment message to obtain merchant identifying information;
further parsing the payment message to obtain at least some payment information for the transaction;
submitting the payment information to a third party settlement processor on behalf of the merchant; and
reporting results of the transaction to at least one of the merchant and the buyer.

2. The method of claim 1, wherein the payment message includes at least one of a credit card number and a token that may be used to identify a payment card.

3. The method of claim 1, wherein the results of the transaction are reported to the buyer and include an indication that the transaction was declined.

4. The method of claim 1, wherein the results of the transaction are reported to at least one of the supplier and the merchant, and include an indication of an amount to be paid to the merchant.

5. The method of claim 1, further comprising:
using the merchant identifying information to obtain a merchant identifier that uniquely or substantially uniquely identifies the merchant; and
using the merchant identifier to obtain some of the payment information.

6. The method of claim 1, wherein the merchant identifying information is an e-mail address.

7. The method of claim 1, further comprising obtaining some of the payment information from a site of an issuer or from a site of a buyer.

8. A computer-readable medium having thereon instructions executable by a computer processor, the instructions comprising instructions for:
receiving a payment message from a buyer relating to a transaction with a merchant;
parsing the payment message to obtain merchant identifying information;
further parsing the payment message to obtain at least some payment information for the transaction;
submitting the payment information to a third party settlement processor on behalf of the merchant; and
reporting results of the transaction to at least one of the merchant and the buyer.

9. The medium of claim 8, wherein the payment message includes at least one of a credit card number and a token that may be used to identify a payment card.

10. The medium of claim 8, wherein the results of the transaction are reported to the buyer and include an indication that the transaction was declined.

11. The medium of claim 8, wherein the results of the transaction are reported to at least one of the supplier and the merchant, and include an indication of an amount to be paid to the merchant.

12. The medium of claim 8, the instructions further comprising instructions for:
using the merchant identifying information to obtain a merchant identifier that uniquely or substantially uniquely identifies the merchant; and
using the merchant identifier to obtain some of the payment information.

13. The medium of claim 8, wherein the merchant identifying information is an e-mail address.

14. The medium of claim 8, the instructions further comprising instructions for obtaining some of the payment information from a site of an issuer or from a site of a buyer.

15. An apparatus, comprising a computing device having a processor and a memory, the memory storing instructions executable by the processor such that the apparatus is configured to:
receive a payment message from a buyer relating to a transaction with a merchant;
parse the payment message to obtain merchant identifying information;
further parse the payment message to obtain at least some payment information for the transaction;
submit the payment information to a third party settlement processor on behalf of the merchant; and
report results of the transaction to at least one of the merchant and the buyer.

16. The apparatus of claim 15, wherein the payment message includes at least one of a credit card number and a token that may be used to identify a payment card.

17. The apparatus of claim 15, wherein the results of the transaction are reported to the buyer and include an indication that the transaction was declined.

18. The apparatus of claim 15, wherein the results of the transaction are reported to at least one of the supplier and the merchant, and include an indication of an amount to be paid to the merchant.

19. The apparatus of claim 15, further configured to:
use the merchant identifying information to obtain a merchant identifier that uniquely or substantially uniquely identifies the merchant; and
use the merchant identifier to obtain some of the payment information.

20. The apparatus of claim 15, wherein the merchant identifying information is an e-mail address.

21. The apparatus of claim 15, further configured to obtain some of the payment information from a site of an issuer or from a site of a buyer.
